(19) United States
(12) Patent Application Publication
(10) Pub. No.: US 2013/0319728 A1
(43) Pub. Date: Dec. 5, 2013

(54) APPARATUS AND METHOD TO INSULATE A SHAFT

(71) Applicants: Ravi Kumar Musinana, Hyderabad (IN); Venkata Ramarao Janipireddy, Hyderabad (IN)

(72) Inventors: Ravi Kumar Musinana, Hyderabad (IN); Venkata Ramarao Janipireddy, Hyderabad (IN)

(73) Assignee: GENERAL ELECTRIC COMPANY, Schenectady, NY (US)

(21) Appl. No.: 13/485,501

(22) Filed: May 31, 2012

(51) Int. Cl. H01B 17/56; B21D 53/10

(52) U.S. Cl. 174/138 R; 29/898

(57) ABSTRACT

An apparatus to insulate a rotatable shaft is provided and includes a sleeve disposable about the rotatable shaft and including an exterior surface on which a bearing seat is mountable, a first insulation part interposable between an axial surface of the mountable bearing seat and a corresponding axial surface of the rotatable shaft and a second insulation part interposable between a radial surface of the sleeve and a corresponding radial surface of the rotatable shaft.

### BACKGROUND OF THE INVENTION

The subject matter disclosed herein relates to an apparatus and method to insulate a rotatable shaft and, more particularly, to an apparatus and method to insulate bearings from shaft currents by insulating a rotating shaft for variable frequency drive (VFD) applications.

A variable-frequency drive (VFD) system is a system for controlling rotational speed of an alternating current (AC) electric motor by controlling a frequency of the electrical power supplied to the motor. A variable frequency drive is a specific type of adjustable-speed drive and may be known as adjustable-frequency drives (AFD), variable-speed drives (VSD), AC drives, microdrives or inverter drives. VFD systems are used in a wide number of applications to control pumps, fans, hoists, conveyors and other machinery.

In VFD applications, however, a problem exists in that shaft currents induced along rotatable shafts may cause bearing pitting in the shaft bearings. To prevent this from happening, the bearings may be insulated with ceramic coatings. Such insulated bearings are relatively expensive and their use can require higher lead time for procurement.

### BRIEF DESCRIPTION OF THE INVENTION

According to one aspect of the invention, an apparatus to insulate a rotatable shaft is provided. The apparatus includes a sleeve disposable about the rotatable shaft and including an exterior surface on which a bearing seat is mountable, a first insulation part interposable between an axial surface of the mountable bearing seat and a corresponding axial surface of the rotatable shaft and a second insulation part interposable between a radial surface of the sleeve and a corresponding radial surface of the rotatable shaft.

According to another aspect of the invention, an apparatus to insulate a bearing seat from a rotatable shaft is provided. The apparatus includes a base insulation part interposable between an axial surface of the mountable bearing seat and a corresponding axial surface of the rotatable shaft and a composite insulation part including reinforcing structures interposable between a radial surface of the bearing seat and a corresponding radial surface of the rotatable shaft.

According to yet another aspect of the invention, a method of insulating a bearing seat from a rotatable shaft is provided. The method includes mounting the bearing seat about the rotatable shaft and interposing first and second insulation parts between an axial surface of the mounted bearing seat and a corresponding axial surface of the rotatable shaft and between a radial surface of the mounted bearing seat and a corresponding radial surface of the rotatable shaft, respectively.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective, partially exploded view of an apparatus to insulate a rotatable shaft in accordance with embodiments;

FIG. 2 is a side view of the apparatus of FIG. 1; and

FIG. 3 is a side view of an apparatus to insulate a rotatable shaft in accordance with alternative embodiments.

The detailed description explains embodiments of the invention, together with advantages and features, by way of example with reference to the drawings.

### DETAILED DESCRIPTION OF THE INVENTION

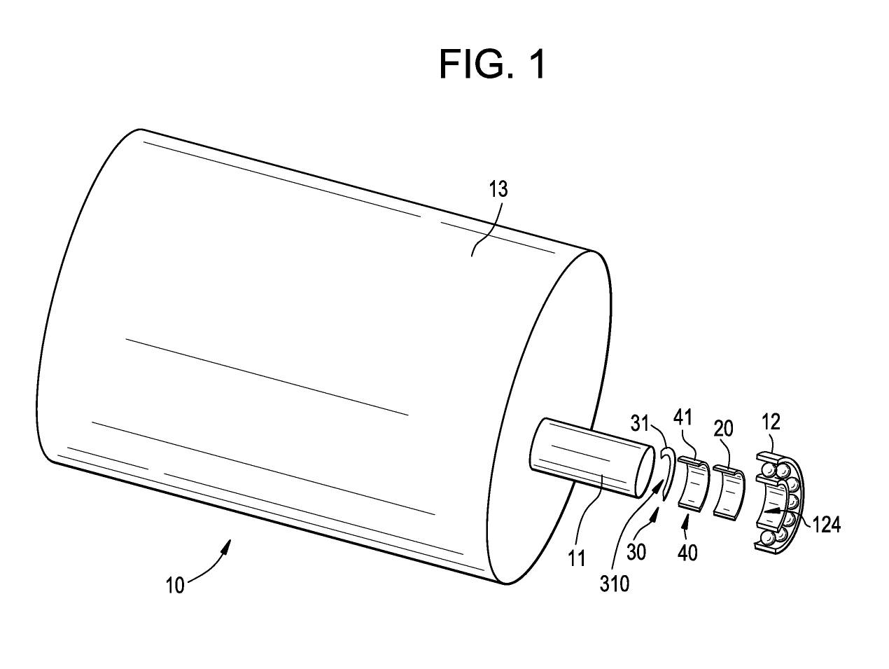

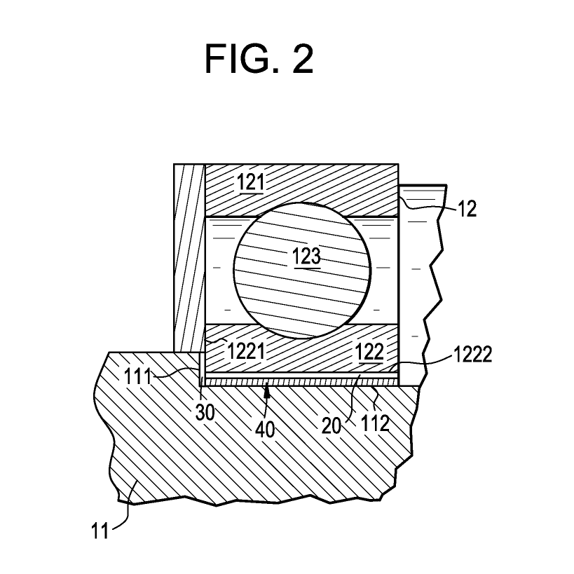

With reference to FIGS. 1 and 2, an apparatus 10 is provided to insulate a rotatable shaft 11 at locations where bearing components 12 for rotatably supporting the rotatable shaft 11 are seated. The rotatable shaft 11 is rotatably disposed to extend through a drive element 13 such that an end of the rotatable shaft 11 protrudes axially outwardly from the drive element 13. In some embodiments, the drive element 13 may be provided as a variable frequency drive (VFD) element. In any case, the rotation of the rotatable shaft 11 may lead to the generation of circulating rotor shaft currents that could damage the bearing components 12 but for the insulation provided by the apparatus 10.

A shoulder of the rotatable shaft 11 includes an axial surface 111 proximate to an end of the drive element 13. An exterior surface of the rotatable shaft 11 includes a radial surface 112. When assembled together, the bearing components 12 may be seatably disposed adjacent to the axial surface 111 and about the radial surface 112. The bearing components 12 include an outer ring 121, a bearing seat 122 and ball bearings 123. The ball bearings 123 are radially and axially secured between the outer ring 121 and the bearing seat 122. The bearing seat 122 is formed to define a bore 124 through which the rotatable shaft 11 is extendable and includes an axial surface 1221 and a radial surface 1222.

The axial surface 1221 is configured to face in an axial direction and to axially oppose the axial surface 111 of the rotatable shaft 11. The radial surface 1222 is configured to face radially inwardly and to radially oppose the radial surface 112 of the rotatable shaft 11.

The apparatus 10 includes a sleeve 20, a first insulation part 30 and a second insulation part 40. The sleeve 20 may be formed of steel or a similar metal or metallic alloy and is disposable in shrunk fit form about a portion of the radial surface 112 of the rotatable shaft 11. The sleeve 20 includes a machinable exterior surface 21 on which the bearing seat 122 is mountable. The first insulation part 30 is interposable between at least a portion of the axial surface 1221 of the bearing seat 122 and a corresponding portion of the axial surface 111 of the rotatable shaft 11. The second insulation part 40 is interposable between an inner diameter of the sleeve 20 and a corresponding portion of the radial surface 112 of the rotatable shaft 11.

The first and second insulation parts 30 and 40 may be formed of different or substantially similar materials provided the materials are electrically insulating. For example, the first and second insulation parts 30 and 40 may be formed of one or more of insulation tape and/or paper.

In accordance with embodiments, the first insulation part 30 may be provided as a ring member 31 that is formed of electrically insulating material. The ring member 31 may be thicker along a radial dimension thereof than along an axial dimension thereof, which is relatively narrow. In this way, the ring member 31 may have a washer-shape with opposite faces and a bore 310 defined through the ring member 31 from one face to the other. Thus, as shown in FIG. 2, since the ring member 31 is relatively narrow in an axial direction, the sleeve 20 and the bearing seat 122 can be mounted proximate to the axial surface 111 of the rotatable shaft 11 and the end of the drive element 13.

The second insulation part 40 may include one of insulation tape and insulation paper and may have a substantially cylindrical shape. Where the second insulation part 40 is substantially cylindrical, the second insulation part 40 is interposable between a substantially cylindrical portion of an inner diameter of the sleeve 20 and a corresponding substantially cylindrical portion of the radial surface 112 of the rotatable shaft 11. The second insulation part 40 may include a plurality of sleeve member portions 41. For example, the second insulation part 40 may include two sleeve member portions 41 of electrically insulating materials that each extends about halfway around the rotatable shaft 11. When these two (or more) sleeve member portions 41 are positioned in a circumferential end-to-end configuration, an entire circumference of the rotatable shaft 11 may be surrounded by the second insulation part 40.

Still referring to FIGS. 1 and 2, a method of insulating the rotatable shaft 11 may include disposing the first insulation part 30 against the axial surface 111 of the rotatable shaft 11 and disposing the second insulation part 40 about the radial surface 112 of the rotatable shaft 11. The disposing of the first insulation part 30 against the axial surface 111 of the rotatable shaft 11 may be accomplished by slidably directing the rotatable shaft 11 through the bore 310. The disposing of the second insulation part 40 about the radial surface 112 of the rotatable shaft 11 may be accomplished by enwrapping the portion of the radial surface 112 of the rotatable shaft 11 with portions (i.e., the two (or more) sleeve member portions 41) of the second insulation part 40 and then shrink fitting the sleeve 20 about the second insulation part 40. This serves to interpose the second insulation part 40 between the shrunk fit sleeve 20 and the radial surface 112 of the rotatable shaft 11.

Once the sleeve 20 is shrunk fit, the exterior surface 21 thereof may be machined to substantially match a topography of the radial surface 1222 of the bearing seat 122. This may be accomplished by any suitable machining process or processes. At this point, the bearing seat 122 may be mounted onto the machined exterior surface 21 of the sleeve 20 such that the axial surface 1221 of the mounted bearing seat 122 is disposed against the first insulation part 30, which is itself disposed against the axial surface 111 of the rotatable shaft 11.

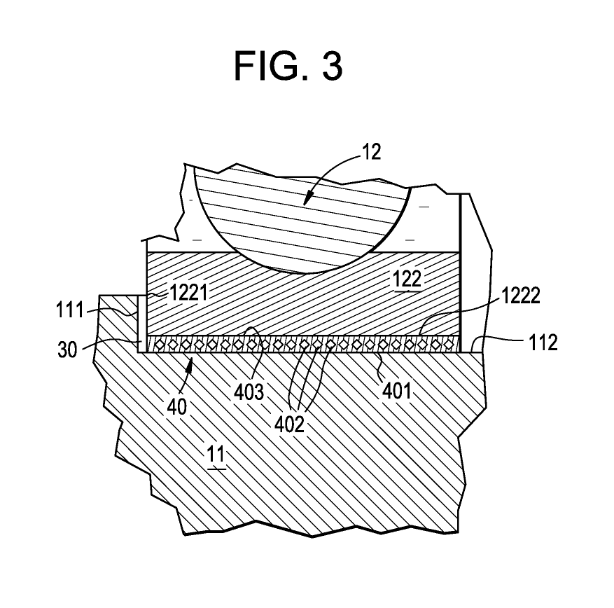

With reference to FIG. 3 and, in accordance with alternative embodiments, the apparatus 10 may include the first (or “base”) insulation part 30, as described above, and a second (or “composite”) insulation part 400. The composite insulation part 400 may be employed instead of the second insulation part 40 and the sleeve 20. As shown in FIG. 3, the composite insulation part 400 may be formed as an insulation band 401 with reinforcing structures 402. The insulation band 401 is formed of electrically insulating materials and is interposable between a portion of the radial surface 1222 of the bearing seat 122 and a corresponding portion of the radial surface 112 of the rotatable shaft 11. The reinforcing structures 402 may be formed of warped glass fibers that are molded about the rotatable shaft 11.

The composite insulation part 400 may be formed by disposing the insulation band 401 with glass fibers provided therein about the rotatable shaft 11 such that the glass fibers become at least partially warped. The insulation band is then cured by, for example, baking processes, to harden the glass fibers into the reinforcing structures 402. At this point, an exterior surface 403 of the composite insulation part 400 may be machined to substantially match a topography of the radial surface 1222 of the bearing seat 122. This may be accomplished by any suitable machining process or processes. The bearing seat 122 may then be mounted onto the machined exterior surface 403 of the composite insulation part 400 such that the axial surface 1221 of the mounted bearing seat 122 is disposed against the first insulation part 30, which is itself disposed against the axial surface 111 of the rotatable shaft 11.

In accordance with the description provided above, the bearing components 12 are insulated from shaft current. The insulation is cost effective as compared to other insulation methods, such as the use of ceramic bearings.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus to insulate a rotatable shaft, comprising:
a sleeve disposable about the rotatable shaft and including an exterior surface on which a bearing seat is mountable;
a first insulation part interposable between an axial surface of the mountable bearing seat and a corresponding axial surface of the rotatable shaft; and
a second insulation part interposable between a radial surface of the sleeve and a corresponding radial surface of the rotatable shaft.

2. The apparatus according to claim 1, wherein the sleeve comprises steel.

3. The apparatus according to claim 1, wherein the first and second insulation parts are formed of substantially similar materials.

4. The apparatus according to claim 1, wherein the first insulation part comprises a ring member formed of electrically insulating material.

5. The apparatus according to claim 4, wherein the ring member is thicker in a radial dimension thereof than an axial dimension thereof

6. The apparatus according to claim 1, wherein the second insulation part is interposable between a substantially cylindrical radial surface of the sleeve and a corresponding substantially cylindrical radial surface of the rotatable shaft.

7. The apparatus according to claim 1, wherein the second insulation part comprises a plurality of sleeve member portions that are each formed of electrically insulating material.

8. The apparatus according to claim 1, wherein the second insulation part comprises one of insulation tape and insulation paper.

9. An apparatus to insulate a bearing seat from a rotatable shaft, comprising:
a base insulation part interposable between an axial surface of the mountable bearing seat and a corresponding axial surface of the rotatable shaft; and
a composite insulation part including reinforcing structures interposable between a radial surface of the bearing seat and a corresponding radial surface of the rotatable shaft.

10. The apparatus according to claim 9, wherein the base insulation part comprises a ring member formed of electrically insulating material.

11. The apparatus according to claim 9, wherein the composite insulation part is interposable between a substantially cylindrical radial surface of the bearing seat and a corresponding substantially cylindrical radial surface of the rotatable shaft.

12. The apparatus according to claim 9, wherein the composite insulation part comprises a band having warped glass reinforcing structures.

13. A method of insulating a bearing seat from a rotatable shaft, the method comprising:
mounting the bearing seat about the rotatable shaft; and
interposing first and second insulation parts between an axial surface of the mounted bearing seat and a corresponding axial surface of the rotatable shaft and between a radial surface of the mounted bearing seat and a corresponding radial surface of the rotatable shaft, respectively.

14. The method according to claim 13, wherein the interposing of the first and second insulation parts comprises:
disposing the first and second insulation parts against the axial surface of the rotatable shaft and about the radial surface of the rotatable shaft, respectively;
shrink fitting a sleeve about the second insulation part to interpose the second insulation part between the shrunk fit sleeve and the radial surface of the rotatable shaft;
machining an exterior surface of the shrunk fit sleeve; and
mounting the bearing seat onto the machined exterior surface of the shrunk fit sleeve such that the axial surface of the mounted bearing seat is disposed against the first insulation part.

15. The method according to claim 14, wherein the disposing of the first insulation part comprises slidably directing the rotatable shaft through a bore defined through the first insulation part.

16. The method according to claim 14, wherein the disposing of the second insulation part comprises enwrapping the radial surface of the rotatable shaft with portions of the second insulation part.

17. The method according to claim 13, wherein the interposing of the first and second insulation parts comprises:
disposing the first and second insulation parts against the axial surface of the rotatable shaft and about the radial surface of the rotatable shaft, respectively; and
mounting the bearing seat onto an exterior surface of the second insulation part such that the axial surface of the mounted bearing seat is disposed against the first insulation part.

18. The method according to claim 17, wherein the disposing of the first insulation part comprises slidably directing the rotatable shaft through a bore defined through the first insulation part.

19. The method according to claim 17, wherein the disposing of the second insulation part comprises:
disposing a reinforced insulation band about the radial surface of the rotatable shaft;
curing the reinforced insulation band; and
machining the exterior surface of the reinforced insulation band.

20. The method according to claim 19, further comprising reinforcing an insulation band with warped glass reinforcing structures to form the reinforced insulation band.
